(19) United States
(12) Patent Application Publication
(10) Pub. No.: US 2025/0365601 A1
(43) Pub. Date: Nov. 27, 2025

(54) CHANNEL STATE INFORMATION MEASUREMENT AND REPORT ENHANCEMENT

(71) Applicant: ZTE CORPORATION, Shenzhen (CN)

(72) Inventors: Minqiang ZOU, Shenzhen (CN); Bo GAO, Shenzhen (CN); Ke YAO, Shenzhen (CN); Wenjun YAN, Shenzhen (CN); Zhaohua LU, Shenzhen (CN)

(73) Assignee: ZTE CORPORATION, Shenzhen (CN)

(21) Appl. No.: 19/294,596

(22) Filed: Aug. 8, 2025

Related U.S. Application Data
(63) Continuation of application No. PCT/CN2023/076292, filed on Feb. 15, 2023.

(51) Int. Cl. H04W 24/10; H04L 5/00

(52) U.S. Cl. CPC H04W 24/10; H04L 5/0051

(57) ABSTRACT

Aspects of this technical solution can include receiving, by a wireless communication device from a network, a plurality of reference signal resources and a plurality of configuration parameters, where the plurality of reference signal resources comprise a plurality of Channel State Information—Reference Signal (CSI-RS) resources and a plurality of Channel State Information—Interference Measurement (CSI-IM) resources, and the plurality of configuration parameters comprise Codebook Subset Restriction (CBSR), determining, by a wireless communication device, a Channel State Information (CSI) report based on the plurality of reference signal resources and the plurality of configuration parameters, and transmitting, by the wireless communication device to the network, the CSI report.

### CROSS-REFERENCE TO RELATED APPLICATION

This application claims the benefit of priority under 35 U.S.C. § 120 as a continuation of PCT Patent Application No. PCT/CN2023/076292, filed on Feb. 15, 2023, the disclosure of which is incorporated herein by reference in its entirety.

### TECHNICAL FIELD

The present implementations relate generally to wireless communications, and more particularly to systems, methods, apparatuses, and non-transitory computer-readable media for channel state information measurement and report enhancement.

### BACKGROUND

Multiple-input-multiple-output (MIMO) is one of the key technologies in New Radio (NR) systems and is successful in commercial deployment. MIMO features are specified for both frequency division duplex (FDD) and time division duplex (TDD) systems. Considering ideal backhaul and synchronization as well as the same number of antenna ports across TRPs, enhancements in channel state information (CSI) acquisition for Coherent-Joint Transmission (CJT) is needed. Significant loss of performance for a user equipment (UE) at high or medium speed can occur in commercial deployments, especially in multi-user MIMO (MU-MIMO) scenarios. As performance loss is partly caused by CSI, enhancements to CSI measurement and report to alleviate such loss can be beneficial.

### SUMMARY

This technical solution can include a new design of CSI-RS and CSI-IM configuration for CJT CSI measurement and reporting. In addition, this technical solution can include a new design of codebook subset restriction for Type-II codebook refinement for the case of CJT and high/medium velocity CSI measurement and reporting.

At least one aspect is directed to a wireless communication method. The method can include receiving, by a wireless communication device from a network, a plurality of reference signal resources and a plurality of configuration parameters, where the plurality of reference signal resources comprise a plurality of Channel State Information-Reference Signal (CSI-RS) resources and a plurality of Channel State Information-Interference Measurement (CSI-IM) resources, and the plurality of configuration parameters comprise Codebook Subset Restriction (CBSR). The method can include determining, by a wireless communication device, a Channel State Information (CSI) report based on the plurality of reference signal resources and the plurality of configuration parameters. The method can include transmitting, by the wireless communication device to the network, the CSI report.

At least one aspect is directed to a wireless communication method. The method can include sending, by a network to wireless communication device, a plurality of reference signal resources and a plurality of configuration parameters, where the plurality of reference signal resources comprise a Channel State Information-Reference Signal (CSI-RS) resource and Channel State Information- Interference Measurement (CSI-IM) resource, and the plurality of configuration parameters comprise Codebook Subset Restriction (CBS). The method can include receiving, by the network from the wireless communication device, a Channel State Information (CSI) report determined by the wireless communication device based on the plurality of reference signal resources and the plurality of configuration parameters.

The above and other aspects and their implementations are described in greater detail in the drawings, the descriptions, and the claims.

### BRIEF DESCRIPTION OF THE DRAWINGS

These and other aspects and features of the present implementations is apparent to those ordinarily skilled in the art upon review of the following description of specific implementations in conjunction with the accompanying figures, wherein:

FIG. 1 is a diagram illustrating an example wireless communication network, according to various arrangements.

FIG. 2 is a diagram illustrating a block diagram of an example wireless communication system for transmitting and receiving downlink and uplink communication signals, according to various arrangements.

FIG. 3 depicts an example CMR configuration, in accordance with present implementations.

FIG. 4 depicts an example CMR configuration, in accordance with present implementations.

FIG. 5 depicts an example CMR configuration, in accordance with present implementations.

FIG. 6 depicts an example CMR configuration, in accordance with present implementations.

FIG. 7 depicts an example CMR configuration, in accordance with present implementations.

FIG. 8 depicts an example CMR configuration, in accordance with present implementations.

FIG. 9 depicts an example CMR configuration, in accordance with present implementations.

FIG. 10 depicts an example CMR configuration, in accordance with present implementations.

FIG. 11 depicts an example CMR configuration, in accordance with present implementations.

FIG. 12 depicts an example method of channel state information measurement and report enhancement, in accordance with present implementations.

FIG. 13 depicts an example method of channel state information measurement and report enhancement, in accordance with present implementations.

FIG. 14 depicts an example method of channel state information measurement and report enhancement, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations is described, and detailed descriptions of other portions of such known components is omitted so as not to obscure the present implementations. Implementations described as being implemented in software should not be limited thereto, but can include implementations implemented in hardware, or combinations of software and hardware, and vice-versa, as is apparent to those skilled in the art, unless otherwise specified herein. In the present specification, an implementation showing a singular component should not be considered limiting. Rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

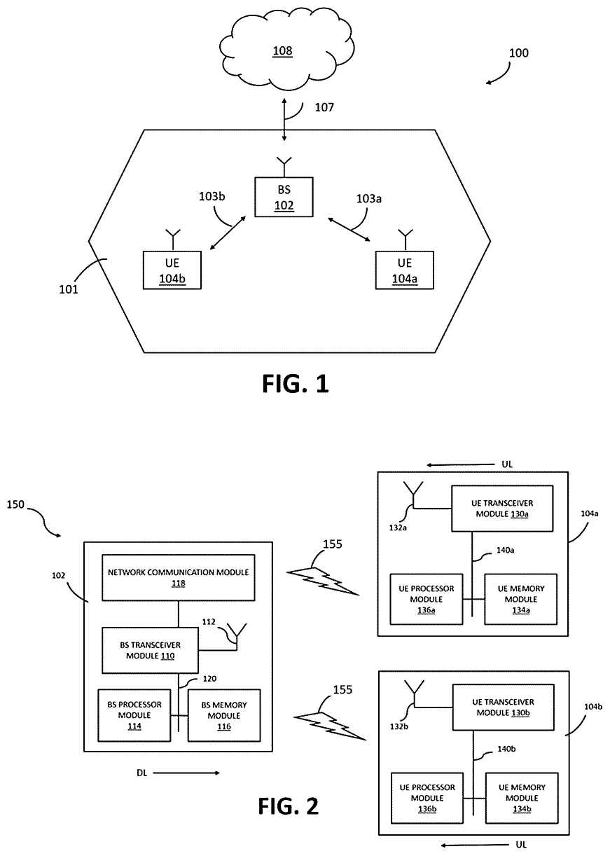

FIG. 1 shows an example wireless communication network 100. The wireless communication network 100 corresponds to a group communication or a multicast service within a cellular network. In the wireless communication network 100, a network-side communication node or a base station (BS) can include one or more of a next Generation Node B (gNB), an E-Utran Node B (also known as Evolved Node B, eNodeB or eNB), a pico station, a femto station, a Transmission/Reception Point (TRP), an Access Point (AP), or the like. A terminal-side node or a UE can include a long-range communication system (such as but not limited to, a mobile device, a smart phone, a Personal Digital Assistant (PDA), a tablet, a laptop computer) or a short-range communication system (such as but not limited to, a wearable device, a vehicle with a vehicular communication system, or the like). As in FIG. 1, a network-side communication node is represented by a BS 102, and a terminal-side communication node is represented by a UE 104a or 104b. In some arrangements, the BS 102 is sometimes referred to as a “wireless communication node,” and the UE 104a/104b is sometimes referred to as a “wireless communication device.”

As shown in FIG. 1, the BS 102 can provide wireless communication services to the UEs 104a and 104b within a cell 101. The UE 104a can communicate with the BS 102 via a communication channel 103a. Similarly, the UE 104b can communicate with the BS 102 via a communication channel 103b. The communication channels (e.g., 103a and 103b) can be through interfaces such as but not limited to, an Uu interface which is also known as Universal Mobile Telecommunication System (UMTS) air interface. The BS 102 is connected to a Core Network (CN) 108 through an external interface 107, e.g., an NG interface.

FIG. 2 illustrates a block diagram of an example wireless communication system 150 for transmitting and receiving downlink and uplink communication signals, in accordance with some arrangements of the present disclosure. Referring to FIGS. 1 and 2, the system 150 is a portion of the network 100. In the system 150, data symbols can be transmitted and received in a wireless communication environment such as the wireless communication network 100 of FIG. 1.

The system 150 generally includes the BS 102 and UEs 104a and 104b. The BS 102 includes a BS transceiver module 110, a BS antenna 112, a BS memory module 116, a BS processor module 114, and a network communication module 118. The modules/components are coupled and interconnected with one another as needed via a data communication bus 120. The UE 104a includes a UE transceiver module 130a, a UE antenna 132a, a UE memory module 134a, and a UE processor module 136a. The modules/components are coupled and interconnected with one another as needed via a data communication bus 140a. Similarly, the UE 104b includes a UE transceiver module 130b, a UE antenna 132b, a UE memory module 134b, and a UE processor module q136b. The modules/components are coupled and interconnected with one another as needed via a data communication bus 140b. The BS 102 communicates with the UEs 104a and 104b via communication channels 155, which can be any wireless channel or other medium known in the art suitable for transmission of data as described herein.

The system 150 can further include any number of modules/elements other than the modules/elements shown in FIG. 2. The various illustrative blocks, modules, elements, circuits, and processing logic described in connection with the arrangements disclosed herein can be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionalities. Whether such functionalities are implemented as hardware, firmware, or software depends upon the particular application and design constraints imposed on the overall system. Those familiar with the concepts described herein may implement such functionalities in a suitable manner for each particular application, but such implementation decisions should not be interpreted as limiting the scope of the present disclosure.

A wireless transmission from an antenna of each of the UEs 104a and 104b to an antenna of the BS 102 is known as an uplink transmission, and a wireless transmission from an antenna of the BS 102 to an antenna of each of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter circuitry and receiver circuitry that are each coupled to the respective antenna 132a and 132b. A duplex switch may alternatively couple the uplink transmitter or receiver to the uplink antenna in time duplex fashion. Similarly, the BS transceiver module 110 may be herein referred to as a downlink transceiver, or BS transceiver. The downlink transceiver can include RF transmitter circuitry and receiver circuitry that are each coupled to the antenna 112. A downlink duplex switch may alternatively couple the downlink transmitter or receiver to the antenna 112 in time duplex fashion. The operations of the transceivers 110, 130a, and 130b are coordinated in time such that the uplink receiver is coupled to the antenna 132a and 132b for reception of transmissions over the wireless communication channels 155 at the same time that the downlink transmitter is coupled to the antenna 112. In some arrangements, the UEs 104a and 104b can use the UE transceivers 130a and 130b through the respective antennas 132a and 132b to communicate with the BS 102 via the wireless communication channels 155. The wireless communication channel 155 can be any wireless channel or other medium suitable for downlink (DL) and/or uplink (UL) transmission of data as described herein.

The UE transceiver 130a/130b and the BS transceiver 110 are configured to communicate via the wireless data communication channel 155, and cooperate with a suitably configured antenna arrangement that can support a particular wireless communication protocol and modulation scheme. In some arrangements, the UE transceiver 130a/130b and the BS transceiver 110 are configured to support industry standards such as the Long-Term Evolution (LTE) and emerging 5G standards, or the like. It is understood, however, that the present disclosure is not necessarily limited in application to a particular standard and associated protocols. Rather, the UE transceiver 130a/130b and the BS transceiver 110 may be configured to support alternate, or additional, wireless data communication protocols, including future standards or variations thereof.

The processor modules 136a and 136b and 114 may be each implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods or algorithms described in connection with the arrangements disclosed herein may be embodied directly in hardware, in firmware, in a software module executed by processor modules 114, 136a, and 136b, respectively, or in any practical combination thereof. The memory modules 116, 134a, 134b can be realized as RAM memory, flash memory, ROM memory, EPROM memory, EEPROM memory, registers, a hard disk, a removable disk, a CD-ROM, or another suitable form of storage medium. In this regard, the memory modules 116, 134a, and 134b may be coupled to the processor modules 114, 136a, and 136b, respectively, such that the processors modules 114, 136a, and 136b can read information from, and write information to, the memory modules 116, 134a, and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 114, 136a, and 136b, respectively. Memory modules 116, 134a, and 134b may also each include non-volatile memory for storing instructions to be executed by the processor modules 114, 136a, and 136b, respectively.

The network interface 118 generally represents the hardware, software, firmware, processing logic, and/or other components of the BS 102 that enable bi-directional communication between BS transceiver 110 and other network components and communication nodes configured to communication with the BS 102. For example, the network interface 118 may be configured to support internet or WiMAX traffic. In a typical deployment, without limitation, the network interface 118 provides an 802.3 Ethernet interface such that BS transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the BS 102 to communicate with other BSs or core network over a wired or wireless connection.

The BS 102 can communicate with a plurality of UEs (including the UEs 104a and 104b) using multicast or broadcast, collectively referred to as MBS. The plurality of UEs can each receive MBS service via multicast and/or broadcast. In order to receive the MBS service, the plurality of UEs have a common understanding on the configurations of the MBS service, including but not limited to, frequency resource range for resource allocation, scrambling sequence, and so on, referred to herein as PTM configuration, multicast configuration, or MBS configurations. The network (e.g., the BS 102 or the cell 101) can deliver the PTM configuration for MBS multicast reception for the UE 104a or 104b in different RRC states.

In some arrangements, the UE 104a or 104b receives the PTM configuration or updates thereof from the network (e.g., the BS 102 or the cell 101) through dedicated signaling specific to the UE. An example of the dedicated signaling includes RRC reconfiguration signaling. For example, when the UE in the RRC-inactive state, the UE initiates the RRC connection resume process to receive the PTM configuration update. When the UE is in the RRC-connected state, the PTM configuration is delivered by the network via dedicated signaling.

At least one aspect is directed to higher layer parameter configuration of CJT CSI for measurement and reporting. For Type-II codebook refinement for multiple transmission reception points (MTRP) Coherent-Joint Transmission (CJT), a higher layer parameter is configured by gNB, and received by a UE. For example, codebookType is set to ‘typeII-r18’ or ‘typeII-MultiPanel-r18.’

At least one aspect is directed to a channel measurement resource (CMR) and interference measurement resource (IMR) configuration of CJT CSI for measurement and reporting. For Type-II codebook refinement for multiple transmission reception points (MTRP) Coherent-Joint Transmission (CJT), CMR and IMR configuration can be enhanced. For example, a CMR set comprises K CMRs, where each CMR is associated with one transmission reception point (TRP). For example, a plurality of IMRs are configured, and each of the plurality of IMRs is associated with the K CMRs.

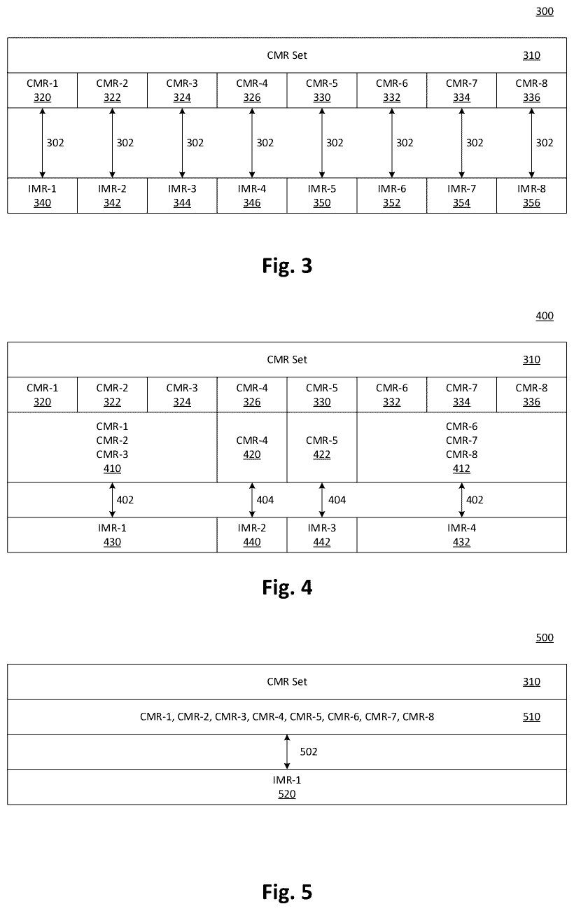

FIG. 3 depicts an example CMR configuration, in accordance with present implementations. As illustrated by way of example in FIG. 3, an example CMR configuration 300 can include at least resource links 302, a CMR set 310, CMR resources 320, 322, 324, 326, 330, 332, 334 and 336, and an IMR resources 340, 342, 344, 346, 350, 352, 354 and 356. For example, a number K IMRs are configured, and each CMR is associated with one IMR. The K IMRs can be zero power IMR (ZP-IMR) and/or nonzero power IMR (NZP-IMR).

FIG. 4 depicts an example CMR configuration, in accordance with present implementations. As illustrated by way of example in FIG. 4, an example CMR configuration 400 can include at least multiple resource links 402, single resource links 404, multiple CMR resource blocks 410 and 412, single CMR resource blocks 420 and 422, multiple IM resource blocks 430 and 432, and single IMR resource blocks 440 and 442. For example, a number M IMRs are configured. One CMR or more than one CMRs is associated with one IMR. For example, M less than or equal to K. The M IMRs can be ZP-IMR and/or NZP-IMR.

FIG. 5 depicts an example CMR configuration, in accordance with present implementations. As illustrated by way of example in FIG. 5, an example CMR configuration 500 can include at least a resource link 502, a multiple CMR resource block 510, and a single IMR resource 520. For example, only one IMR is configured, and all CMRs groups are associated with this IMR. This IMR can be a ZP-IMR and/or an NZP-IMR.

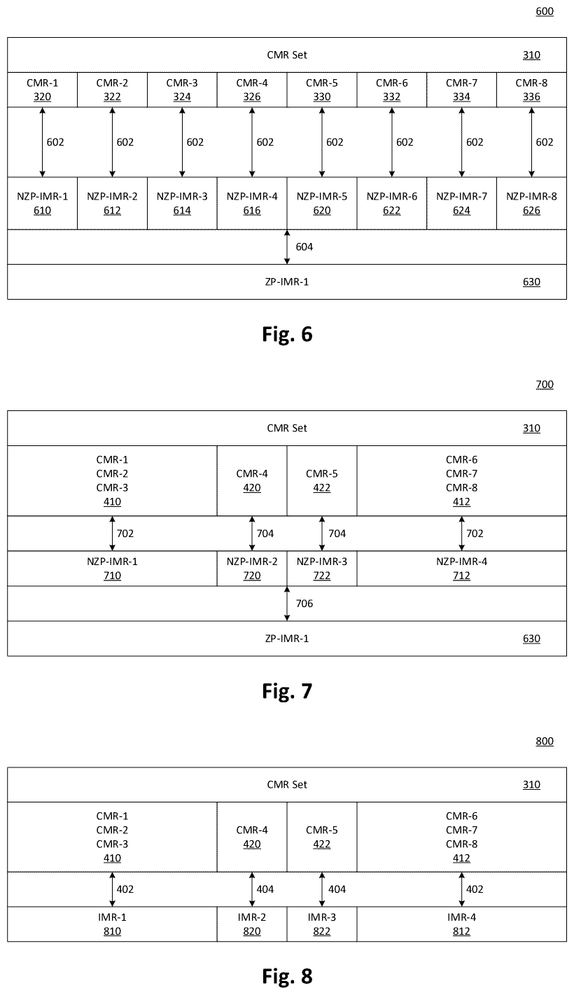

FIG. 6 depicts an example CMR configuration, in accordance with present implementations. As illustrated by way of example in FIG. 6, an example CMR configuration 600 can include at least resource links 602, a resource link 604, NZP-IMR resources 610, 612, 614, 616, 620, 622, 624 and 626, and a ZP-IMR resource 630. For example, multiple NZP-IMRs and only one ZP-IMR are configured, where each CMR is associated with one NZP-IMR and all CMRs are associated with the ZP-IMR.

FIG. 7 depicts an example CMR configuration, in accordance with present implementations. As illustrated by way of example in FIG. 7, an example CMR configuration 700 can include at least resource links 702, 704 and 706. For example, a number M NZP-IMRs and only one ZP-IMR are configured. Here, one or more CMRs is associated with one NZP-IMR. For example, M is less than or equal to K. For example, all CMR groups are associated with the ZP-IMR.

At least one aspect is directed to a codebook subset restriction (CBSR) configuration of CJT CSI for measurement and report. For example, the aspect can be related to the 38.214 5.2.2.2.5 Enhanced Type II Codebook. The bitmap parameter n1-n2-codebookSubsetRestriction-r16 forms the bit sequence B=B₁B₂ and configures the vector group indices g^{(k)} as in clause 5.2.2.2.3. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed average amplitude, γ_{i+pL} (p=0,1), with i ∈{0,1, . . . , L−1}, of the coefficients associated with the vector in group g^{(k)} indexed by x₁, x₂, where the maximum amplitudes are given in Table 1 and the average coefficient amplitude is restricted as follows, for l=1, . . . , υ, and p=0,1:

$$\sqrt{\frac{1}{{\sum }_{f = 0}^{{M}_{v} - 1} {k}_{l , i + pL , f}^{( 3 )}} {\sum }_{f = 0}^{{M}_{v} - 1} {{k}_{l , i + pL , f}^{( 3 )} ( {p}_{l , p}^{( 1 )} {p}_{l , i + pL , f}^{( 2 )} )}^{2}} \leq {γ}_{i + pL} \qquad Eqn . ( 1 )$$

TABLE 1
Maximum allowed average coefficient
amplitudes for restricted vectors.

| | Maximum |
|---|---|
| | Average |
| | Coefficient |
| Bit | Amplitude |
| b₂^{(k, 2(N}^{₁}^{x}^{₂}^{+x}^{₁}⁾⁺¹⁾b₂^{(k, 2(N}^{₁}^{x}^{₂}^{+x}^{₁}⁾⁾ | γ_{i+pL} |
| 00 | 0 |
| 01 | \sqrt{¼} |
| 10 | \sqrt{½} |
| 11 | 1 |

For example, the Type-II codebook refinement for multiple transmission reception points (MTRP) Coherent-Joint Transmission (CJT), CBSR configuration can be enhanced. For CJT, the CMR set comprises K CMRs. K CMRs make up N CMR groups. For example, N is less than or equal to K, and each CMR group is associated with one transmission reception point (TRP), where K₁+K₂ + . . . +K_{N}=K.

For example, a bitmap parameter is configured by gNB, and can be received by UE. For each layer and each polarization, an average coefficient amplitude can be determined based on wideband amplitude and subband amplitude across L CMR groups. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

can indicate the maximum allowed average amplitude, γ_{i+pL} (p=0,1), with i ∈{0,1, . . . , L−1}, of the coefficients associated with the vector in group g^{(k)} indexed by x₁, x₂, where the maximum amplitudes are given in Table 1 and the average coefficient amplitude is restricted as follows, for l=1, . . . , υ, and p=0,1:

$$\sqrt{\frac{1}{{\sum }_{f = 0}^{{M}_{v} - 1} {\sum }_{n = 0}^{N - 1} {k}_{l , i + pL , f , n}^{( 3 )}} {\sum }_{f = 0}^{{M}_{v} - 1} {\sum }_{n = 0}^{N - 1} {{k}_{l , i + pL , f , n}^{( 3 )} ( {p}_{l , p}^{( 1 )} {p}_{l , i + pL , f , n}^{( 2 )} )}^{2}} \leq {γ}_{i + pL} \qquad Eqn . ( 2 )$$

For example, a number N bitmap parameters are configured by gNB, receiving by UE. Each bitmap parameter is associated with one CMR group. For each layer, each polarization and each CMR group, an average coefficient amplitude can be determined based on wideband amplitude and subband amplitude. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

can indicate the maximum allowed average amplitude, γ_{i+pL,n} (p=0,1 and n=0,1 . . . . N−1), with i ∈{0,1, . . . , L−1}, of the coefficients associated with the vector in group g^{(k)} indexed by x₁, x₂, where the maximum amplitudes are given in Table 1 and the average coefficient amplitude is restricted as follows, for l=1, . . . , υ,p=0,1 and n=0,1 . . . . N−1:

$$\sqrt{\frac{1}{{\sum }_{f = 0}^{{M}_{v} - 1} {k}_{l , i + pL , f , n}^{( 3 )}} {\sum }_{f = 0}^{{M}_{v} - 1} {{k}_{l , i + pL , f , n}^{( 3 )} ( {p}_{l , p}^{( 1 )} {p}_{l , i + pL , f , n}^{( 2 )} )}^{2}} \leq {γ}_{i + pL , n} \qquad Eqn . ( 3 )$$

In Rel-16, the UE is configured with restrictions for 4 vector groups for the only one bitmap parameter. In Rel-18, the UE can be configured with restrictions for different number of vector groups for the N bitmap parameters. For example, [K₀, K₁, . . . , KN−1] are associated with a number N CMR groups, where K₀, =K₁, = . . . , =K_{N-1}=4, [K₀, K₁, . . . , KN₋₁] is configured by gNB, and [K₀, K₁, . . . , KN₋₁] is up to UE capability.

At least one aspect is directed to CBSR configuration of Doppler CSI for measurement and reporting. For example, the Type-II codebook refinement for high/medium velocities, time-domain correlation/Doppler-domain information is used for CSI measurement and reporting. A number Q

Doppler domain basis vectors are selected to obtain a Type-II codebook. As a result, CBSR configuration for Doppler CSI measurement and report can be enhanced. For example, a bitmap parameter is configured by gNB, receiving by UE.

For each layer and each polarization, the average coefficient amplitude is determined based on wideband amplitude and subband amplitude across Q Doppler domain basis. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed average amplitude, γ_{i+pL} (p=0,1), with i ∈{0,1, . . . , L−1}, of the coefficients associated with the vector in group g^{(k)} indexed by x₁, x₂, where the maximum amplitudes are given in Table 1 and the average coefficient amplitude is restricted as follows, for l=1, . . . , υ, and p=0,1:

$$\sqrt{\frac{1}{{\sum }_{f = 0}^{{M}_{v} - 1} {\sum }_{q = 0}^{Q - 1} {k}_{l , i + pL , f , q}^{( 3 )}} {\sum }_{f = 0}^{{M}_{v} - 1} {\sum }_{q = 0}^{Q - 1} {{k}_{l , i + pL , f , q}^{( 3 )} ( {p}_{l , p}^{( 1 )} {p}_{l , i + pL , f , q}^{( 2 )} )}^{2}} \leq {γ}_{i + pL} \qquad Eqn . ( 4 )$$

For example, Q bitmap parameters are configured by gNB, receiving by UE, where each bitmap parameter is associated with one division domain (DD) basis vector. For each layer, each polarization and each DD basis vector, an average coefficient amplitude is determined based on wideband amplitude and subband amplitude. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

can indicate the maximum allowed average amplitude, γ_{i+pL,q} (p=0,1 and q=0,1 . . . . N−1), with i∈ {0,1, . . . , L−1}, of the coefficients associated with the vector in group g^{(k)} indexed by x₁, x₂, where the maximum amplitudes are given in Table 1 and the average coefficient amplitude is restricted as follows, for l=1, . . . , υ, p=0,1 and q=0,1. . . . N−1:

$$\sqrt{\frac{1}{{\sum }_{f = 0}^{{M}_{v} - 1} {k}_{l , i + pL , f , q}^{( 3 )}} {\sum }_{f = 0}^{{M}_{v} - 1} {{k}_{l , i + pL , f , q}^{( 3 )} ( {p}_{l , p}^{( 1 )} {p}_{l , i + pL , f , q}^{( 2 )} )}^{2}} \leq {γ}_{i + pL , q} \qquad Eqn . ( 5 )$$

For example, the bit sequence B₂=B₂⁽⁰⁾B₂⁽¹⁾B₂⁽²⁾B₂⁽³⁾ is the concatenation of the bit sequences B₂^{(k)} for k=0,1, . . . ,3, corresponding to the group indices g^{(k)}. The bit sequence B₂^{(k)} is defined as:

$${B}_{2}^{( k )} = {b}_{2}^{( k , 2 {N}_{1} {N}_{2} - 1 )} ⋯ {b}_{2}^{( k , 0 )} \qquad Eqn . ( 7 )$$

Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed amplitude coefficient

$${p}_{l , i}^{( 1 )}$$

for the vector in group g^{(k)} indexed by x₁, x₂. For example, in Rel-18, B₂ and B₂^{(k,q)} can be enhanced. For example,

$${B}_{2} = {B}_{2}^{( 0 , 0 )} {B}_{2}^{( 1 , 0 )} {B}_{2}^{( 2 , 0 )} {B}_{2}^{( 3 , 0 )} ( {B}_{2}^{( 0 , 1 )} , {B}_{2}^{( 1 , 1 )} , {B}_{2}^{( 2 , 1 )} , {B}_{2}^{( 3 , 1 )} ) ⋯ {B}_{2}^{( 0 , Q - 1 )} {B}_{2}^{( 1 , Q - 1 )} {B}_{2}^{( 2 , Q - 1 )} {B}_{2}^{( 3 , Q - 1 )} .$$

For example,

$${B}_{2}^{( k , q )} = {b}_{2}^{( k , q , 2 {N}_{1} {N}_{2} - 1 )} ⋯ {b}_{2}^{( k , q , 0 )} .$$

For example, an n1-n2-codebookSubsetRestriction can correspond to a number of antenna ports in first (n1) and second (n2) dimension and a codebook subset restriction. For example, a number of bits for codebook subset restriction is CEIL (log2(nchoosek(O1*O2,4)))+8*n1*n2 where nchoosek (a, b)=a!/(b!(a-b)!). For example, a bit string size of n1-n2-codebookSubsetRestriction can be enhanced.

At least one aspect is directed to CMR and IMR configuration of Doppler CSI for measurement and reporting. For example, the Type-II codebook refinement for high/medium velocities and time-domain correlation/Doppler-domain information is used for CSI measurement and reporting. In this case, CMR and IMR configuration can be enhanced. For an aperiodic CSI-RS configuration, a semi-persistent CSI-RS configuration or a periodic CSI-RS configuration, a CMR set comprises K CMRs. For example, a plurality of IMRs are configured, and associated with the K number of CMRs.

FIG. 8 depicts an example CMR configuration, in accordance with present implementations. As illustrated by way of example in FIG. 8, an example CMR configuration 800 can include at least multiple IMR resource blocks 810 and 812, and single IMR resource blocks 820 and 822. For example, a number M IMRs are configured, where one or more CMRs is associated with one IMR. For example, M is less than or equal to K. For example, the M IMRs can be ZP-IMR and/or NZP-IMR.

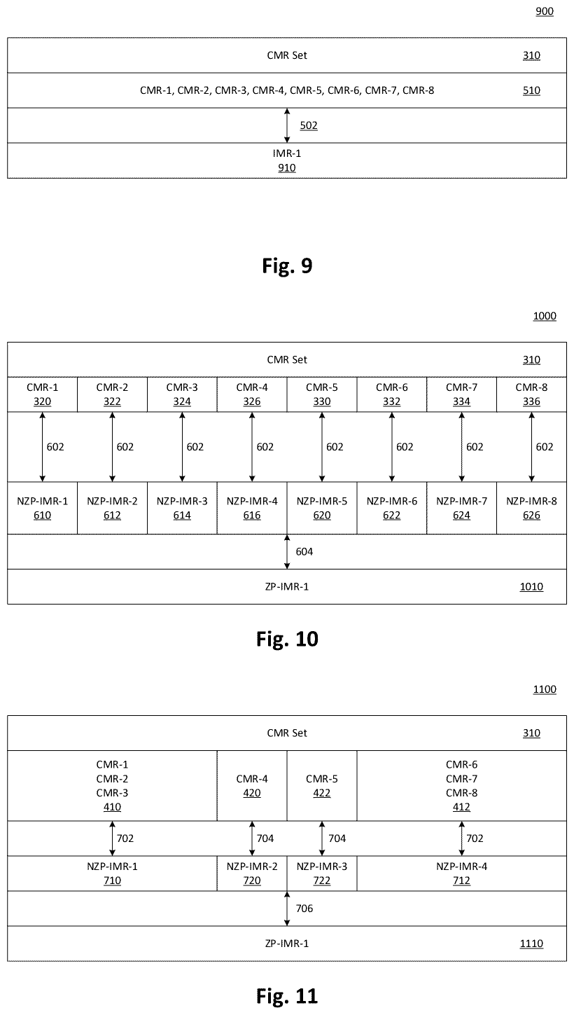

FIG. 9 depicts an example CMR configuration, in accordance with present implementations. As illustrated by way of example in FIG. 9, an example CMR configuration 900 can include at least a single IMR resource 910. For example, only one IMR is configured, and all CMRs are associated with this IMR. For example, the IMR can be ZP-IMR and/or NZP-IMR.

FIG. 10 depicts an example CMR configuration, in accordance with present implementations. As illustrated by way of example in FIG. 10, an example CMR configuration 1000 can include at least a single ZP-IMR resource 1010. For example, a number K NZP-IMRs and only one ZP-IMR are configured, where each CMR is associated with one NZP-IMR, and all CMRs are associated with the ZP-IMR.

FIG. 11 depicts an example CMR configuration, in accordance with present implementations. As illustrated by way of example in FIG. 11, an example CMR configuration 1100 can include at least a single ZP-IMR resource 1110. For example, a number M NZP-IMRs and only one ZP-IMR are configured, where one CMR or more than one CMRs is associated with one NZP-IMR. For example, M is less than or equal to K, and all CMR groups are associated with the ZP-IMR.

At least one aspect is directed to priority formulation of Doppler CSI. For example, a value of priority is determined by one or more of a frequency domain (FD) basis, spatial domain (SD) basis and Layer. For Enhanced Type II reports, for a given CSI report n, each reported element of subband amplitude, subband phase and the location of coefficients, indexed by l, i and f, can be associated with a priority value Pri(l, i, f)=2·L·υ·π(f)+υ·i+l, with

$$π ( f ) = min ( 2 \cdot {n}_{3 , l}^{( f )} , 2 \cdot ( {N}_{3} - {n}_{3 , l}^{( f )} ) - 1 )$$

with l=1,2, . . . , υ, i=0,1, . . . ,2L−1, and f=0,1, . . . , M_{υ}−1, and where

$${n}_{3 , l}^{( f )}$$

is defined in Clause 5.2.2.2.5. The element with the highest priority has the lowest associated value Pri (l, i, f). For example, a value of Pri can be based on an FD-basis over an SD-basis, which is over a Layer. For example, the Type-II codebook refinement for high/medium velocities, time-domain correlation/Doppler-domain information is used for CSI measurement and reporting. For example, a number Q Doppler domain basis vectors are selected for obtain Type-II codebook. For example, for Type-II codebook refinement for high/medium velocities, a parameter Q or another parameter Q is used for time compression.

For Type-II codebook refinement for high/medium velocities, priority formulation can be enhanced. For example, a value of priority is determined by a Doppler domain (DD) basis, FD basis, SD basis and Layer. For example, Pri (l, i, f, q)=2L*v*Mᵥ*func(q)+2L*v*π(f)+v*i+l, q=0,1,2 . . . . Q−1, where func(q)=q or func(q)=π(q), π(q)=min (2*q, 2*(Q−1)−1).

For Type-II codebook refinement for high/medium velocities, priority formulation can be enhanced. For example, a value of priority is determined by a FD basis, DD basis, SD basis and Layer. For example, Pri (l, i, f, q)=2L*v*Q*π(f)+2L*v*func(q)+v*i+l, q=0,1,2 . . . . Q−1, where func(q)=q or func(q)=π(q), π(q)=min (2*q, 2*(Q−1)−1). For example, the priority value of each element is determined by Pri(l, i, f, q)=2L*v*Mᵥ*func(q)+2L*v*π(f)+v*i+l, q=0,1,2 . . . . Q−1, wherein l=1,2, . . . , υ, i=0,1, . . . ,2L−1, and f=0,1, . . . , M_{υ}−1 and wherein func(q)=q; or func(q)=π(q), π(q) =min(2*q, 2*(Q−1)−1).

For example, the priority value if each element is determined by Pri(l, i, f, q)=2L*v*Q*π(f) +2L*v*func(q)+v*i+l, q=0,1,2 . . . . Q−1 wherein l=1,2,. . . , υv, i=0,1, . . . ,2L−1, and f=0,1, . . . , M_{υ}−1 and wherein func(q)=q; or func(q)=π(q), π(q)=min(2*q, 2*(Q31 1)−-1).

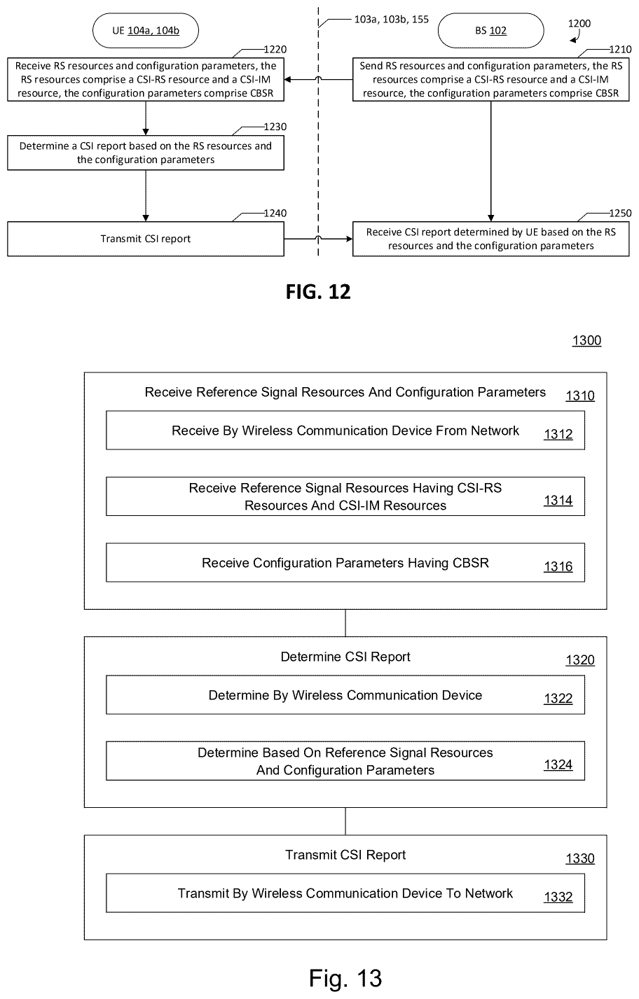

FIG. 12 depicts an example method of channel state information measurement and report enhancement, in accordance with present implementations. At least one of the UE 104a or 104b or the BS 102 can perform method 1200. At 1210, the method 1200 can send RS resources and configuration parameters, the RS resources comprise a CSI-RS resource and a CSI-IM resource, the configuration parameters comprise CBSR. At 1220, the method 1200 can receive RS resources and configuration parameters, the RS resources comprise a CSI-RS resource and a CSI-IM resource, the configuration parameters comprise CBSR. At 1230, the method 1200 can determine a CSI report based on the RS resources and the configuration parameters. At 1240, the method 1200 can transmit a CSI report. At 1250, the method 1200 can receive CSI report determined by UE based on the RS resources and the configuration parameters.

FIG. 13 depicts an example method of channel state information measurement and report enhancement, in accordance with present implementations. At least one of the UE 104a or 104b or the BS 102 can perform method 1300. At 1310, the method 1300 can receive reference signal resources and configuration parameters. At 1312, the method 1300 can reference signal resources and configuration parameters receive by a wireless communication device from a network. At 1314, the method 1300 can receive reference signal resources having CSI-RS resources and CSI-IM resources. At 1316, the method 1300 can receive configuration parameters having CBSR. At 1320, the method 1300 can determine a CSI report. At 1322, the method 1300 can determine a CSI report by a wireless communication device. At 1324, the method 1300 can determine a CSI report based on the reference signal resources and the configuration parameters. At 1330, the method 1300 can transmit the CSI report. At 1332, the method 1300 can transmit by the wireless communication device to the network.

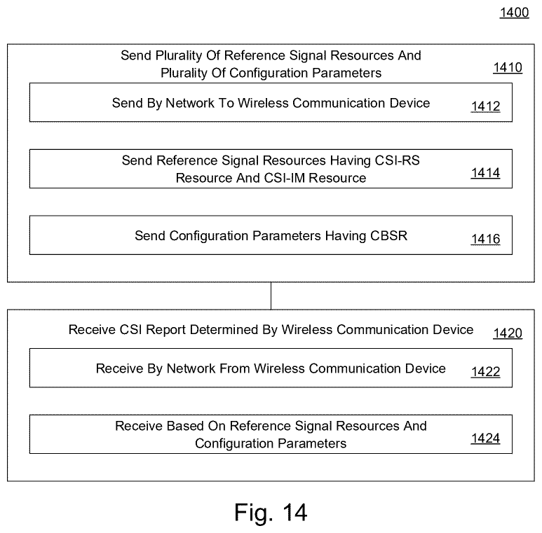

FIG. 14 depicts an example method of channel state information measurement and report enhancement, in accordance with present implementations. At least one of the UE 104a or 104b or the BS 102 can perform method 1400. At 1410, the method 1400 can send a plurality of reference signal resources and a plurality of configuration parameters. At 1412, the method 1400 can send reference signal resources and configuration parameters by a network to wireless communication device. At 1414, the method 1400 can send reference signal resources having CSI-RS resource and CSI-IM resource. At 1416, the method 1400 can send configuration parameters having CBSR. At 1420, the method 1400 can receive a CSI report determined by the wireless communication device. At 1422, the method 1400 can receive a CSI report by the network from the wireless communication device. At 1424, the method 1400 can receive a CSI report based on the reference signal resources and the configuration parameters.

At last, one aspect is directed to determining, by a wireless communication device, that the CSI report comprises a first CSI part and a second CSI part, the second CSI part comprising group 0, group 1 and group 2. Here, group 1 comprises a bitmap indicating the pairs of non-zero coefficients associated with at least one precoder. The pairs can be associated with a Frequency-domain basis vector and Doppler-domain basis vector, a spatial-domain basis vector and Frequency-domain basis vector; or a spatial-domain basis vector and Doppler-domain basis vector. Each of the at least one coefficient of the corresponding precoder can be associated with a priority value. The priority value can be determined based on the SD basis index, pair index and layer index, on the DD basis index, pair index and layer index, or on the FD basis index, pair index and layer index. Group 2 can include a bitmap indicating the lowest priority of half of non-zero coefficients associated with the precoder. Group 1 can include a bitmap indicating the highest priority of the remain coefficients of Group 2 associated with the precoder.

For example, the method can include receiving, by the wireless communication from the network, a higher layer parameter indicating a codebook type can include a Type-II codebook, where the CSI report is configured using a codebook can corresponding to the codebook type. For example, the method can include receiving, by the wireless communication from the network, a plurality of Channel Measurement Resources (CMRs) and at least one Interference Measurement Resource (IMR) associated with the plurality of CMRs, the plurality of CSI-RS resources can comprise the plurality of CMRs and the at least one IMR, and the CSI-IM resources can comprise the at least one IMR, where the CSI report is configured for a Coherent-Joint Transmission (CJT) CSI report.

For example, in the method, the at least one IMR can comprise a plurality of IMRs. The method can include each of the plurality of CMRs is associated with a respective one of the plurality of IMRs. For example, in the method, the at least one IMR can comprise a plurality of IMRs. The method can include one or more CMRs of the plurality of CMRs are associated with a respective one of the plurality of IMRs. For example, in the method, the at least one IMR can comprise one IMR. The method can include the plurality of CMRs is associated with the one IMR. For example, in the method, the at least one IMR can comprise a plurality of Non-Zero Power (NZP)-IMRs and one Zero Power (ZP)-IMR. The method can include each of the plurality of CMRs is associated with a respective one of the plurality of NZP-IMRs. The method can include the plurality of CMRs is associated with the one ZP-IMR. For example, in the method, the at least one IMR can comprise a plurality of Non-Zero Power (NZP)-IMRs and one Zero Power (ZP)-IMR. The method can include at least one CMR of the plurality of CMRs is associated with a respective one of the plurality of NZP-IMRs. The method can include the plurality of CMRs is associated with the one ZP-IMR.

For example, the method can include receiving, by the wireless communication from the network, a plurality of Channel Measurement Resources (CMRs), each of the plurality of CMRs is associated with a Transmission Reception Point (TRP), the CSI report is configured for a Coherent- Joint Transmission (CJT) CSI report. For example, in the method, the CBS can comprise a bitmap parameter having a plurality of bits, the plurality of bits in the bitmap parameter indicating a maximum allowed average amplitude. The method can include the method further can comprise determining, by the wireless communication device for each layer and each polarization, an average coefficient amplitude based on a wideband amplitude and a subband amplitude across the plurality of CMRs. For example, in the method, the CBS can comprise a plurality of bitmap parameters having a plurality of bits, the plurality of bits in each bitmap parameter indicating a maximum allowed average amplitude for a respective one of the plurality of CMRs. The method can include the method further can comprise determining, by the wireless communication device for each layer, each polarization, and each of the plurality of CMRs, an average coefficient amplitude based on a wideband amplitude and a subband amplitude.

For example, in the method, a plurality of numbers of vector groups can correspond to the plurality of CMRs, where each of the plurality of numbers of vector groups is configured by the network. For example, in the method, a plurality of numbers of vector groups can correspond to the plurality of CMRs, where each of the plurality of numbers of vector groups is determined based on a capability of the wireless communication device. For example, in the method, the CSI report can comprise a Doppler CSI report. For example, in the method, the CBSR can comprise a bitmap parameter having a plurality of bits, the plurality of bits in the bitmap parameter indicating a maximum allowed average amplitude. The method can include the method further can comprise determining, by the wireless communication device for each layer and each polarization, an average coefficient amplitude based on a wideband amplitude and a subband amplitude across a number of Doppler- domain basis. For example, in the method, the CBSR can comprise a plurality of bitmap parameters each having a plurality of bits, the plurality of bits in each bitmap parameter indicating a maximum allowed average amplitude for a respective Doppler-domain basis vector. The method can include the method further can comprise determining, by the wireless communication device for each layer, each polarization, and each Doppler-domain basis vector, an average coefficient amplitude based on a wideband amplitude and a subband amplitude.

For example, a plurality of numbers of vector groups can correspond to a plurality of Doppler- domain basis vectors, where each of the plurality of numbers of vector groups is 4. The method can include or a plurality of numbers of vector groups can correspond to the plurality of Doppler-domain basis vectors, where the plurality of numbers of vector groups is configured by the network. The method can include or a plurality of numbers of vector groups can correspond to the plurality of Doppler-domain basis vectors, where each of the plurality of numbers of vector groups is determined based on a capability of the wireless communication device.

For example, the method can include receiving, by the wireless communication from the network, a plurality of Channel Measurement Resources (CMRs) and at least one Interference Measurement Resource (IMR) associated with the plurality of CMRs, the plurality of CSI-RS resources can comprise the plurality of CMRs and the at least one IMRs, and the CSI-IM resources can comprise the at least one IMRs.

For example, the method can include receiving, by the wireless communication from the network, a plurality of Channel Measurement Resources (CMs) and at least one InterferenceMeasurement Resource (IMR) associated with the plurality of CMRs, the plurality of CSI-RS resources can comprise the plurality of CMRs and the at least one IMR, and the CSI-IM resources can comprise the at least one IMR, where the CSI report is configured for a Doppler CSI report.

For example, in the method, the at least one IMR can comprise a plurality of IMRs. The method can include one or more CMRs of the plurality of CMRs are associated with a respective one of the plurality of IMRs. For example, in the method, the at least one IMR can comprise one IMR. The method can include the plurality of CMRs is associated with the IMR. For example, in the method, the at least one IMR can comprise a plurality of Non-Zero Power (NZP)-IMRs and one Zero Power (ZP)-IMR. The method can include each of the plurality of CMRs is associated with a respective one of the plurality of NZP-IMRs. The method can include the plurality of CMRs is associated with the one ZP-IMR. For example, in the method, the at least one IMR can comprise a plurality of Non-Zero Power (NZP)-IMs and one Zero Power (ZP)-IMR. The method can include one or more of the plurality of CMRs are associated with a respective one of the plurality of NZP-IMRs. The method can include the plurality of CMRs is associated with the one ZP-IMR.

For example, the method can include determining, by a wireless communication device, the CSI can comprise at least one coefficient associated with at least one Precoding Matrix Indicator (PMI). For example, in the method, each of the at least one coefficient is associated with a priority value. The method can include the priority value is determined by the index of DD basis, FD basis, SD basis and Layer. For example, in the method, the CSI report can comprise at least one element, each of the at least one element can comprise a subband amplitude, a subband phase, and a location of coefficients. The method can include each reported element is associated with a priority value.

For example, various terminology can apply to aspects of this technical solution as discussed herein. However, this technical solution is not limited to the terminology below and included for illustration by way of example. Thus, aspects of this technical solution can relate to one or more of a discrete Fourier transform (DFT), a channel state information reference signal (CSI-RS), a precoding matrix indicator (PMI), a strongest coefficient indicator (SCI), a non-zero coefficient (NZC), and multiple transmission reception points (MTRP).

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It is understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is further understood by those within the art that if a specific number of an introduced claim

recitation is intended, such an intent is explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to the disclosure containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It is further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” is understood to include the possibilities of “A” or “B” or “A and B”.

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the disclosure be defined by the claims appended hereto and their equivalents.

What is claimed is:

1. A wireless communication method, comprising:
receiving, by a wireless communication device from a network, an indication of a set of Channel State Information-Interference Measurement (CSI-IM) resources; and
receiving, by a wireless communication device from the network, an indication of an Interference Measurement Resource (IMR), wherein the set of CSI-IM resources comprises the IMR.

2. The wireless communication method of claim 1, comprising:
receiving, by the wireless communication device from the network, an indication of a set of Channel Measurement Resources (CMRs), wherein the set of CMRs is associated with the IMR.

3. The wireless communication method of claim 2, wherein:
the IMR comprises a Non-Zero Power (NZP)-IMR; and
the set of CMRs is associated with the NZP-IMR.

4. The wireless communication method of claim 1, comprising:
receiving, by the wireless communication device from the network, an indication of at least a resource link.

5. A wireless communication device, comprising:
at least one processor configured to:
receive, via a receiver from a network, an indication of a set of Channel State Information- Interference Measurement (CSI-IM) resources; and
receive, via the receiver from the network, an indication of an Interference Measurement Resource (IMR), wherein the set of CSI-IM resources comprises the IMR.

6. The wireless communication device of claim 5, wherein the at least one processor is configured to:
receive, via the receiver from the network, an indication of a set of Channel Measurement Resources (CMRs), wherein the set of CMRs is associated with the IMR.

7. The wireless communication device of claim 6, wherein:
the IMR comprises a Non-Zero Power (NZP)-IMR; and
the set of CMRs is associated with the NZP-IMR.

8. The wireless communication device of claim 5, wherein the at least one processor is configured to:
receive, via the receiver from the network, an indication of at least a resource link.

9. A wireless communication method, comprising:
sending, by a network to a wireless communication device, an indication of a set of Channel State Information-Interference Measurement (CSI-IM) resources; and
sending, by the network to the wireless communication device, an indication of an Interference Measurement Resource (IMR), wherein the set of CSI-IM resources comprises the IMR.

10. The wireless communication method of claim 9, comprising:
sending, by the network to the wireless communication device, an indication of a set of Channel Measurement Resources (CMRs), wherein the set of CMRs is associated with the IMR.

11. The wireless communication method of claim 10, wherein:
the IMR comprises a Non-Zero Power (NZP)-IMR; and
the set of CMRs is associated with the NZP-IMR.

12. The wireless communication method of claim 9, comprising:
sending, by the network to the wireless communication device, an indication of at least a resource link.

13. A network node, comprising:
at least one processor configured to:
send, via a transmitter to a wireless communication device, an indication of a set of Channel State Information-Interference Measurement (CSI-IM) resources; and
send, via the transmitter to the wireless communication device, an indication of an Interference Measurement Resource (IMR), wherein the set of CSI-IM resources comprises the IMR.

14. The network node of claim 13, comprising:
send, via the transmitter to the wireless communication device, an indication of a set of Channel Measurement Resources (CMRs), wherein the set of CMRs is associated with the IMR.

15. The network node of claim 14, wherein:
the IMR comprises a Non-Zero Power (NZP)-IMR; and
the set of CMRs is associated with the NZP-IMR.

16. The network node of claim 13, comprising:
send, via the transmitter to the wireless communication device, an indication of at least a resource link.
